(19) United States
(12) Patent Application Publication
(10) Pub. No.: US 2026/0230121 A1
(43) Pub. Date: Aug. 6, 2026

(54) MULTIPLE USER MULTIPLE INPUT MULTIPLE OUTPUT (MU-MIMO) TRANSMISSION PRECODER MANAGEMENT USING NEIGHBOR LISTS

(71) Applicant: Kyocera Corporation, Kyoto (JP)

(72) Inventor: Amit KALHAN, San Diego, CA (US)

(21) Appl. No.: 19/146,698

(22) PCT Filed: Jan. 26, 2024
(86) PCT No.: PCT/US2024/013107

§ 371 Date: Jul. 9, 2025

Related U.S. Application Data
(60) Provisional application No. 63/442,572, filed on Feb. 1, 2023.

(51) Int. Cl. H04B 7/0452; H04B 7/0456

(52) U.S. Cl. CPC H04B 7/0452; H04B 7/0456

(57) ABSTRACT

A reporting user equipment (UE) device transmits, to a serving base station, a neighbor list and wide-beam precoder information that is used by the base station to establish a wide-beam precoder. The base station applies a Multiple User Multiple Input Multiple Output (MU-MIMO) precoder for transmissions through multiple antennas to the reporting UE device and the other UE devices identified in the neighbor list where the MU-MIMO precoder uses the wide-beam precoder. The MU-MIMO precoder is a combination of the wide-beam precoder and at least one other precoder. The reporting UE device generates the neighbor list that comprises UE identifiers of other UE devices that are within a maximum distance from the reporting UE device where the maximum distance can be specified by the base station.

### CLAIM OF PRIORITY

The present application claims priority to Provisional Application No. 63/442,572, entitled “Device-to-Device Neighbor List Assisted Multiuser MIMO Transmissions,” docket number TPRO 00382 US, filed Feb. 1, 2023, assigned to the assignee hereof and hereby expressly incorporated by reference in its entirety.

### FIELD

This invention generally relates to wireless communications and more particularly to Multiple User Multiple Input Multiple Output (MU-MIMO) transmission precoder management using neighbor lists.

### BACKGROUND

Many wireless communication systems that employ several base stations that provide wireless service to user equipment (UE) devices enable sidelink communication between two or more UE devices where the UE devices can communicate directly with other UE devices. In addition, one or more UE devices can be used as relay devices between a source UE device and a destination UE device where the relay devices forward data received from the source UE device to the destination UE device. In many conventional communication systems, a serving base station (serving gNB) applies a precoder matrix to transmissions to the UE devices through multiple antennas at the base station. Some systems utilize Multiple User Multiple Input Multiple Output (MU-MIMO) techniques for transmission of signals from multiple antennas at a base station to multiple UE device where a MU-MIMO precoder matrix is applied to the transmissions to enhance the achievable data rates of the transmission to each UE device. With MU-MIMO, a multi-antenna transmitter communicates simultaneously with multiple receivers. Each receiver may have one or multiple antennas. The MU-MIMO precoder facilitates beam forming or other communication channel adjustments where transmission antenna beams are formed to maximize the signal strength of each stream directed to each target UE device.

### SUMMARY

A reporting user equipment (UE) device transmits, to a serving base station, a neighbor list and wide-beam precoder information. The base station applies a MU-MIMO precoder to transmissions through multiple antennas to the reporting UE device and the other UE devices identified in the neighbor list where the MU-MIMO precoder uses a wide-beam precoder (W1) based, at least partially, on the wide-beam precoder information. The reporting UE device generates the neighbor list that comprises UE identifiers of other UE devices that are within a maximum distance from the reporting UE device where the maximum distance can be specified by the base station.

### BRIEF DESCRIPTION OF THE DRAWINGS

FIG. 1A is a block diagram of a communication system where a reporting UE device transmits a neighbor list and wide-beam precoder information to a serving base station.

FIG. 1B is a block diagram of the system for an example where the base station applies a different wide-beam precoder to each UE device cluster of multiple UE clusters.

FIG. 1C is a block diagram of an example of an antenna beam configuration for a MU-MIMO precoder that is equal to the product of a wide-beam precoder (W1), an intermediate-wide precoder (W3), and a UE-specific precoder (W2).

FIG. 2 is a block diagram of an example of a base station suitable for use as the base station of FIG. 1.

FIG. 3 is a block diagram of an example of a UE device suitable for use as each of the UE devices.

FIG. 4 is a message flow diagram for an example where a MU-MIMO precoder is applied to transmissions to three UE devices in a UE cluster and the MU-MIMO precoder is the product of a wide-beam precoder for the UE cluster provided by a reporting UE device of the UE cluster and another precoder based on UE-specific precoder information measured by each UE device.

### DETAILED DESCRIPTION

As discussed above, a serving base station (serving gNB) using MU-MIMO may apply a MU-MIMO precoder (such as a MU-MIMO precoder matrix) to transmissions to the UE devices through multiple antennas at the base station. The channel from the multiple antennas of the base station to an antenna of a UE device is a correlated random vector with covariance matrix that depends on the scattering geometry. Where the base station is a macro-cellular tower-mounted base station with no significant local scattering, the propagation between the base station antennas and any given UE device antenna is characterized by the local scattering around the UE device, resulting in the one-ring model. The signal vector received by the UE devices is given by

$$y = {H}^{H} Wd + z = {H}^{H} x + z$$

where M is the number of base station antennas, K is the number of UE devices, H denotes the M×K system channel matrix given by stacking the K users channel vectors by columns, W is the M×S precoding matrix with S is the rank of the input covariance Σ= [symbol] [Wdd^{H}W^{H}] (i.e., the number of independent data streams sent to the users), d is the S-dimensional transmitted data symbol vector, and z~ [symbol] (0, I) denotes the Gaussian noise at the UE device receiver. The transmit signal vector is given by x=Wd. After appropriate partitioning of the UE devices such that users in the same group are nearly co-located and different groups are sufficiently well separated in the angle of arrival (AoA) domain, the structure of the channel covariance matrices can be leveraged to reduce the dimensionality of the effective channels. As a result, large multiplexing gains are achieved with reduced dimension channel training and Channel State Information (CSI) feedback. The precoding matrix can be split to be a product of two precoders (W=W₁W₂). The two precoders may include a wideband precoder, W₁, and a UE-specific precoder, W₂. With such a precoder product structure, W₂ selects vectors from the wideband W₁ and adjusts the phase between the selected beams. As a result, the wideband and long-term CSI properties are addressed by W₁ while the short-term and frequency-selective CSI properties are addressed by W₂. The required update rate in time and frequency differs between W₁ and W₂. For W₁, the update frequency can be relatively low while the update rate for W₂ is higher.

The resulting precoder in MU-MIMO, therefore, is a combination of the individual precoders. In one example, each precoder is represented by a matrix and the combination of precoders is the product of the matrices. In practice, precoders are implemented by applying a complex-gain (amplitude and phase) weight to each antenna element which can be done in the digital or analog domain or partially in the digital domain and partially in the analog domain (hybrid MIMO processing). The precoding algorithms that compute the antenna weights for each antenna element can be sub-divided into linear and nonlinear precoding types. Nonlinear algorithms result in the maximum data rate achievable for given channel conditions. Although the capacity achieving algorithms are nonlinear, linear precoding technologies typically provide reasonable performance with less complexity. Examples of linear precoding strategies include maximum ratio transmission (MRT), zero-forcing (ZF) precoding, and transmit Wiener precoding. Nonlinear precoding is based on the concept of dirty paper coding (DPC), where any known interference at the transmitter can be subtracted without the penalty of radio resources if the optimal precoding scheme can be applied on the transmit signal.

For the examples herein, a base station uses wide-beam precoder information, provided by a reporting UE device, to determine a wide-beam precoder for transmission to other UE devices that are relatively close to the reporting UE device. The reporting UE device provides the base station with a neighbor list that identifies other UE devices within a maximum distance from the reporting UE device as well as the wide-beam precoder information. The base station uses the wide-beam precoder information to set the wide-beam precoder portion (W₁) of the MU-MIMO precoder (W) for transmissions to the reporting UE device and for transmissions to the other neighbor UE devices. By appropriately setting the maximum distance, the reporting UE device and the neighbor UE devices are considered to be co-located for purposes of the wide-beam precoder, W₁. Signaling overhead is reduced since the channel feedback information related to the wide-beam precoder, W₁, is not transmitted by the neighbor UE devices. For the examples, however, all UE devices report the UE-specific precoder information related to the UE-specific precoder matrix, W₂. As discussed herein, a UE-specific precoder is not necessarily unique to a particular UE device although where UE devices are separated by a sufficient distance, the UE-specific precoders (and MU-MIMO precoders) applied to transmissions to different UE devices are different.

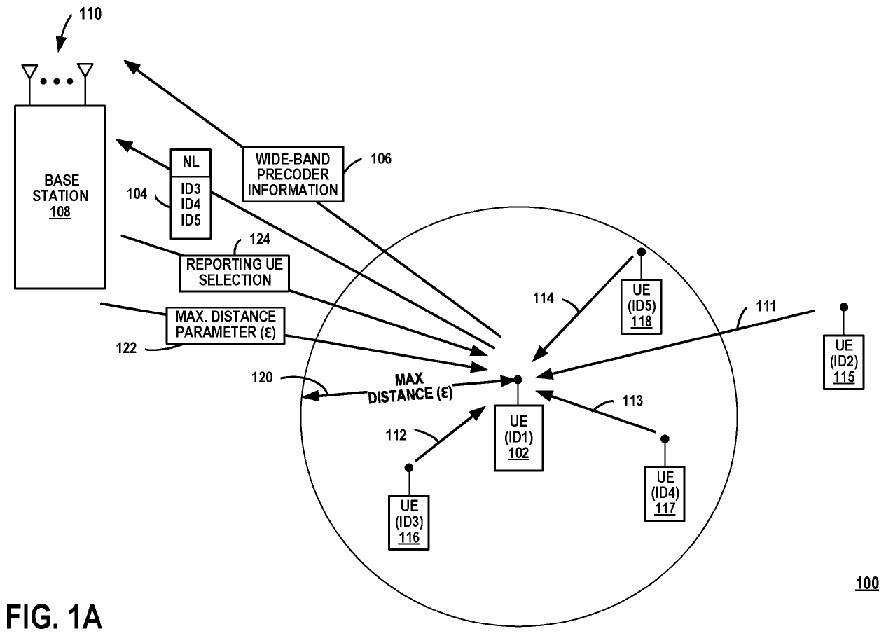

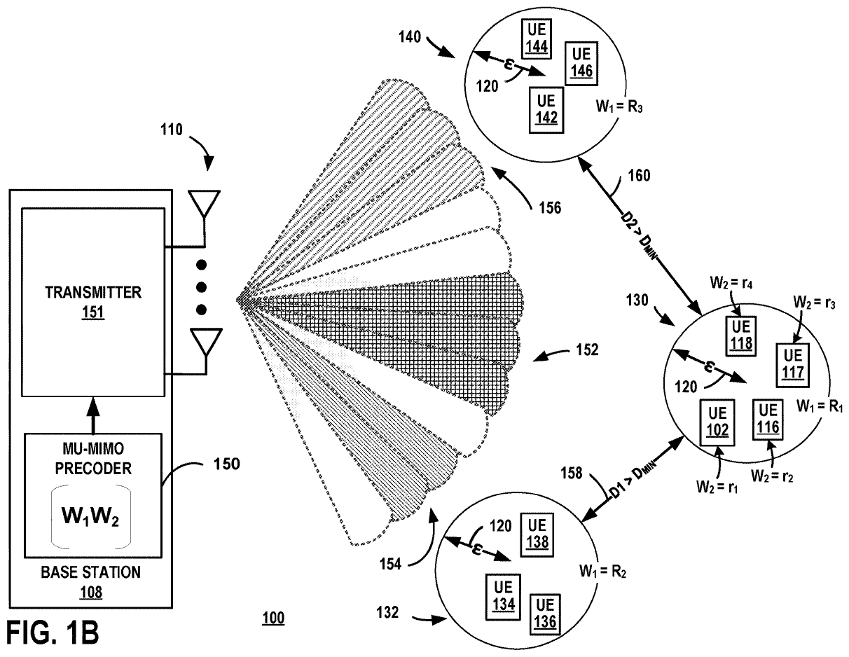

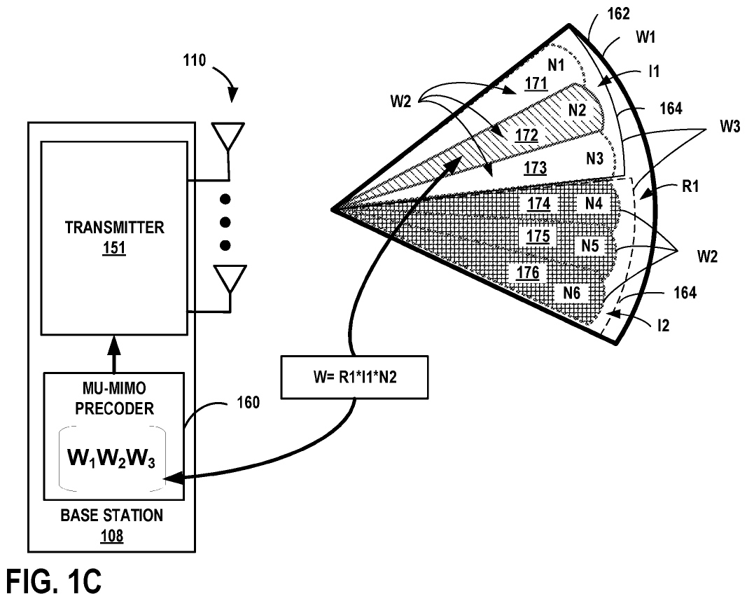

FIG. 1A is a block diagram of a communication system 100 where a reporting UE device 102 transmits a neighbor list 104 and wide-beam precoder information 106 to a serving base station 108. As discussed below in further detail, the base station 108 includes multiple antennas 110 and applies a MU-MIMO precoder to transmissions through the multiple antennas 110 to UE devices. The reporting UE device 102 receives signals 111-114 from a plurality of other UE devices 115-118. Based at least partially on characteristics of the signals and/or information transported by the signals, the reporting UE device 102 identifies a subset of UE devices 116-118 of the plurality of UE devices 115-118 that are within a maximum distance, E, 120 from the reporting UE device 102. The neighbor list 104 identifies each neighbor UE device that is within the maximum distance and may include a UE identifier to identify the UE device, such as Layer 2 IDs and/or a Temporary Mobile Subscriber Identity (S-TMSI). The identified UE devices of the subset, therefore, are the neighbor UE devices 116-118 included in the neighbor list 104. Although the neighbor list 104 may identify several neighbor UE devices, the neighbor list 104 identifies at least one neighbor UE device. In some situations, the neighbor list 104 may identify UE devices that are neighbor devices of the reporting UE but are not within the maximum distance 120. In such situations, the neighbor list 104 includes information identifying which neighbor UE devices are within the maximum distance. One example of suitable information includes a one-bit flag associated with each UE device where the flag value is based on whether the UE device is within the maximum distance 120. In another example, the information includes the distance from the reporting UE device to each neighbor UE device or data indicative of the distance, such as measured signal strength.

In some examples, the signals 111-114 are sidelink discovery signals (device-to-device (D2D) discovery signals). Other UE device transmitted Reference Signals such as Sounding RS (SRS), and/or Sidelink Channel Status Information-Reference Signals (SL-CSI-RS) reports transmitted by the neighboring UE devices may also be used for identifying and listing the neighboring UE devices. The signals 111-114, however, may be any sidelink signal suitable for determining the identity of a UE device and whether the UE device is within the maximum distance 120.

The reporting UE device 102 may determine whether a particular UE device is within the maximum distance 120 based on the measured received signal strength of the signal. With such a technique, therefore, the reporting UE device utilizes the received signal strength as a proxy for distance of all the neighboring UE devices. The neighboring UE devices are added or removed from the NL if the measured signal strength is greater or less than a signal strength threshold (e.g., SignalStrength_{Threshold}), respectively. Where the reporting UE device has multiple antennas, the reporting UE device may also measure the received sidelink signal's Angle-of-Arrival (SL AoA) to determine the direction of the neighboring UE device's transmission. In another approach, if a UE device has location determination capabilities, the UE device may include its geo-location information in sidelink transmission. For example, a UE device may send Global Positioning Satellite (GPS) coordinates, Global Navigation Satellite System (GNSS) coordinates, and/or indoor location. The reporting UE device 102, compares its geolocation to the reported geolocation of the transmitting UE device to determine whether the UE devices are within the maximum distance 120. All the above methods or a subset of these methods, as well as other techniques, can be used to generate the neighbor list that includes both the neighboring device IDs and the associated geo-locations. For the examples discussed below, the neighbor list identifies the UE devices that are within the maximum distance from the reporting UE device and no additional geo-location information is included.

For the example of FIG. 1A, the reporting UE device 102 receives at least one signal 111-114 from each UE device of a plurality of UE devices 115-118 and determines that three UE devices 116-118 are within the maximum distance 120 and that one of the UE devices 115 is not within the maximum distance 120. As a result, the reporting UE device 102 generates the neighbor list to include the UE IDs of the neighbor UE device 116 (UE ID3) of the neighbor UE device 117 (UE ID4) and of the neighbor UE device 118 (UE ID5).

The reporting UE device 102 also determines wide-beam precoder information to be used to determine the covariance wide-beam precoder, W₁, that should be applied by a MU-MIMO precoder at the base station for transmissions through multiple antennas to the reporting UE device 102. In some situations, the reporting UE device 102 measures the channel measured channel covariance matrix, R₁, that determines the wide-beam precoder (W₁) that will be applied by the base station. In other situations, the reporting UE device 102 may identify a wide-beam antenna beam as the best antenna beam. With some techniques, for example, the base station transmits a Synchronization Signal Block (SSB) over several wide-beam antenna beams and the reporting UE device identifies the best wide-beam antenna beam. The wide-beam precoder information may include an SSB indicator that identifies the best SSB antenna beam. The transmitted wide-beam precoder information may also be the measured channel covariance matrix, R₁, or may be an index identifying the wide-beam precoder (W₁) from a set of precomputed matrices. The wide-beam precoder information 106, therefore, may be any information, parameter, or indicator that allows the base station to determine the covariance wide-beam precoder, W₁, for use by the MU-MIMO precoder at the base station 108. For the example, the techniques and procedures for determining the wide-beam precoder information 106 are in accordance with known techniques. The reporting UE device transmits the wide-beam precoder information 106 to the base station 108. In some situations, the wide-beam precoder information 106 and the neighbor list 104 are transmitted in the same signal or message. The wide-beam precoder information 106 may be sent in a separate message or with other messages.

For the example of FIG. 1A, the base station 108 sends a maximum distance parameter message 122 that indicates the maximum distance, ε, 120. In some situations, the message 122 is transmitted via a System Information Broadcast (SIB). The message may be sent using other broadcast techniques as well as by dedicated signaling techniques. The value of the maximum distance, ε, 120 may be updated periodically. In other situations, the maximum distance, ε, 120 is pre-defined in all UE devices and a message is not required. The value of the maximum distance, ε, 120 is based on the particular system implementation which may include several factors, such as the deployment scenario, mobility, channel environment and the frequency band. In some situations, the maximum distance values are determined by conducting field-trials and/or simulations. For the example, the base station sets one maximum distance per hierarchical level defined based on the beam width of the hierarchical level that the base station will use as the upper precoder. Depending upon the channel conditions and the environment, the base station determines max distance for the neighbor list that is appropriate. Also, the base station may determine the maximum distance and the preferred hierarchical level based on the number of transmission antennas available.

For the example of FIG. 1A, the base station 108 selects the UE devices that are to report neighbor lists and wide-beam precoder information. The base station 108 sends a reporting UE selection message 124 to the reporting UE device 102 to notify the UE device of the requirement to report the neighbor list and wide-beam precoder information. The message 124 may include information such as a schedule of reporting, such as the frequency of report transmissions to the base station, and/or events that should trigger a report. The base station and/or the network may set the periodicity of the reports based on factors such as the system deployment scenario, mobility, blockage probability, and the operating frequency band. In some situations, the reporting UE selection message 124 and the maximum distance parameter message 122 are transmitted via the same signal or in the same message.

In many situations, the precoders are based on matrices. In other situations, however, a precoder may be established using other techniques. For example, machine learning (ML) techniques may be utilized to adjust parameters that establish the precoder.

FIG. 1B is a block diagram of the system 100 for an example where the base station 108 applies a different wide-beam precoder to each UE device cluster of multiple UE clusters. For the example, a first UE cluster 130 includes a first reporting UE device 102 and three non-reporting UE devices 116-118, a second UE cluster 132 includes a second reporting UE device 134 and two non-reporting UE devices 136, 138, and a third UE cluster 140 includes a third reporting UE device 142 and two non-reporting UE devices 144, 146. Each reporting UE device 102, 134, 142 sends a neighbor list to the base station 108 reporting the neighbor UE devices that are within the maximum distance and in the cluster. Each reporting UE device 102, 134, 142 also measures the wide-beam precoder and sends wide-beam precoder information indicative of the measured wide-beam precoder. Accordingly, the first reporting UE device 102 transmits a first neighbor list identifying the non-reporting UE devices 116-118 and transmits first wide-beam precoder information to the base station 108. The first reporting UE device 102 measures the first wideband matrix, R₁ and transmits the first wide-beam precoder information indicative of the measured R₁ to the base station 108. The second reporting UE device 134 transmits a second neighbor list identifying the non-reporting UE devices 136, 138 and transmits second wide-beam precoder information to the base station 108. The second reporting UE device 134 measures the second wideband matrix, R₂ and transmits the second wide-beam precoder information indicative of the measured R₂ to the base station 108. The third reporting UE device 142 transmits a third neighbor list identifying the non-reporting UE devices 144, 146 and transmits third wide-beam precoder information to the base station 108. The third reporting UE device 142 measures the third wideband matrix, R₃ and transmits the third wide-beam precoder information indicative of the measured R₃ to the base station 108.

The base station 108 applies a precoder matrix 150 to transmissions for each UE device of a UE cluster that includes the wide-beam precoder identified by the reporting UE device for the particular UE cluster. A transmitter 151 in the base station 108 is connected to the plurality of antennas 110 which may include a single antenna with multiple antenna elements or may include multiple separate antennas. The plurality of antennas 110 may include any number of antennas more than one. The MU-MIMO precoder, W, is the combination of the wide-beam precoder, W₁, and a UE-specific precoder, W₂. The wide-beam precoder, W₁, is set to be the same for all UE devices in a particular UE cluster. Accordingly, the wide-beam precoder, W₁, for transmissions to UE devices 102, 116-118 in the first UE cluster 130 is R₁, the wide-beam precoder, W₁, for transmissions to UE devices 134, 136, 138 in the second UE cluster 132 is R₂, and the wide-beam precoder, W₁, for transmissions to UE devices 142, 144, 146 in the third UE cluster 140 is R₃. The MU-MIMO precoder matrix, W, 150 is also based on the UE-specific precoder, W₂, for the particular UE device. The base station 108 requests the UE device that will receive a transmission to measure and provide UE-specific precoder information that the base station will use to determine the UE-specific precoder. For example, the base station 108 may request that each UE device in the first cluster 130 measure and provide UE-specific precoder information. The base station 108 determines the UE-specific precoder based on the UE-specific precoder information for each device and applies the MU-MIMO precoder data transmission to each UE device where the MU-MIMO precoder uses the UE-specific precoder based on the UE-specific precoder information provided by each UE device and the wide-beam precoder for the cluster. For the example of FIG. 1B, the reporting UE device 102, the UE device 116, the UE device 117, and the UE device 118 each measure channel characteristics based on a precoder measurement configuration provided by the base station to determine the UE-specific precoder information used by the base station to determine the UE-specific precoder, W₂, equal to r₁, r₂, r₃, and r₄, respectively. For the transmissions to the reporting UE device 102, through the multiple antennas 110, the base station 108 applies a precoder matrix based on the first cluster wide-beam precoder and the UE-specific precoder based on the measurements of the reporting UE device 102 (W=W₁W₂=R₁r₁). The precoder matrix for transmissions to the UE device 116 is based on the first cluster wide-beam precoder and the measurements of the UE device 116 to determine the UE-specific precoder (W=W₁W₂=R₁r₂). The precoder matrix for transmissions to the UE device 117 is based on the first cluster wide-beam precoder and the UE-specific precoder information measured by the UE device 117 (W=W₁W₂=R₁r₃). The precoder matrix for transmissions to the UE device 118 is based on the first cluster wide-beam precoder and the UE-specific precoder information measured by the UE device 118 (W=W₁W₂=R₁r₄). The MU-MIMO precoders for transmissions to the UE devices in the other UE clusters are applied similarly resulting in a first subset of beams 152 directed to the first UE cluster 130, a second subset of beams 154 directed to the second UE cluster 132, and a third subset of beams 156 directed to the third UE cluster 140.

In order to have distinct channel covariance matrices, the UE clusters 130, 132, 140 are greater than a critical distance, D_{MIN}, away from each. Accordingly, the distance (D1) 158 between the first UE cluster 130 and the second UE cluster 132 is greater than the critical distance, D_{MIN} and the distance (D2) 160 between the first UE cluster 130 and the second UE cluster 132 is greater than the critical distance, D_{MIN}, for the example.

The type of UE-specific precoder and the techniques used to determine the UE-specific precoder information may vary based on the operating frequency since the MIMO channel characteristics vary based on frequency. For example, the MIMO channel characteristics are different in lower frequency bands (e.g., ~1 to 6 GHZ) vs. higher bands (e.g., 24-30 GHZ) vs. very high bands (e.g., ~70 GHZ), etc. Different MIMO processing and/or precoder techniques may be applied to each frequency band.

For example, the propagation loss in the higher frequency bands is relatively high and the channel experiences much less scattering. In this case, a suitable UE-specific precoder includes a precoder where one or more narrow antenna beams are identified by the UE device and reported to the base station as the UE-specific precoder information.

In the lower frequency bands, however, the propagation loss is not as poor, and the channel experiences much more scattering. In this case, a suitable UE-specific precoder includes a precoder based on amplitude and phase adjusted eigen beams that are linearly combined. In one example, the UE device identifies one or more eigen beams from a subset of eigen beams identified by the base station and provides UE-specific precoder information that at least identifies the eigen beams. An example of a suitable method for identifying the beams includes providing a Precoder Matrix Indicator (PMI). The UE-specific precoder information may also include a rank indicating the number of independent beams (orthogonal beams) and a channel quality indicator (CQI). For example, a codebook may include all possible beam combinations for the multiple antennas at the base station. The UE device reports the indicator from the codebook associated with the best combination. The base station provides the UE device with a subset of beams to evaluate so the UE device can efficiently determine the best combination(s). The base station establishes the UE-specific precoder based on the rank and CQI feedback to linearly combine those beams.

The techniques described above facilitate efficient precoder management. After receiving the neighbor list and the measured wide-beam precoder from the selected reporting UE device 102 in a UE cluster 130, the base station (gNB) 108 assigns all the UE devices 102, 116-118 listed in the neighbor list a wide-beam precoder W₁ of R₁. Consequently, the base station 108 does not need to gather CSI reports from the remaining UE devices 116-118 in the UE cluster 130. When the base station schedules the next MU-MIMO transmission towards one of the UE devices in the first UE cluster, instead of requesting the whole large-dimensioned matrix, W, the base station 108 only requires the short-term/frequency selective dimension-reduced precoder matrix (UE-specific precoder), W₂, from the particular UE device. The UE device may send the UE-specific precoder information explicitly as a measurement or implicitly as an index of a set of precomputed matrices table/codebook representing the UE-specific precoder, W₂. When multiple UE devices report their measured UE-specific precoder, W₂, the overall feedback overhead and latency are greatly reduced compared to conventional techniques where the entire precoder, W, is reported by each UE device.

Although the techniques discussed herein may be applied to various types of systems and communication specifications, the devices of the example operate in accordance with at least one revision of a 3GPP New Radio (NR) V2X communication specification. The techniques discussed herein, therefore, may be adopted by one or more future revisions of communication specifications although the techniques may be applied to other communication specifications where sidelink or D2D is employed. More specifically the techniques may be applied to current and future releases of 3GPP NR specifications. For example, the techniques may also be applied to 3GPP NR (Rel-17). The UE devices 102, 116-118, 134, 136, 138, 142, 144, 146 may be any type of device that can receive signals from, and transmit signals to, base stations and other UE devices. The UE devices operate in the communication system that includes a plurality of base stations that each provide wireless service within a service area. For the examples of FIG. 1A and FIG. 1B, the UE devices may be served by any one of the base stations and may transition between base stations in accordance with known handover techniques.

For the examples above, the MU-MIMO precoder is the product of two precoders. In some situations, however, the MU-MIMO precoder may be based on more than two precoders. In such situations, a hierarchical precoder structure is implemented where each precoder provides an increased level of granularity to the previous precoder. For example, the MU-MIMO precoder may be the combination of a wide-beam precoder, an intermediate precoder, and a UE specific precoder where the wide-beam precoder provides the most general precoder parameters of the MU-MIMO precoder. The same wide-beam precoder, therefore, can be applied to several UE devices within a maximum distance. The intermediate precoder handles short-term and frequency-selective channel parameters of the MU-MIMO precoder and the UE-specific precoder provides the further short-term and frequency-selective channel parameters of the MU-MIMO precoder. In some situations, the intermediate precoder may apply to more than one UE device. Such a situation may be physically observed in an implementation where the MU-MIMO precoder facilitates antenna beams. For example, the wide-beam precoder may provide the widest antenna beam that applies to a first set of UE devices, the intermediate precoder provides intermediate-wide antenna beams narrower than and within the wide-beam antenna beam, and the UE-specific precoder provides the narrowest beams that are within the intermediate-wide antenna beam. As a result, an intermediate-wide antenna beam may apply to a narrower set of UE devices within the first set where the UE devices in the narrower set are closer to each other than the UE devices in the first set. Therefore, intermediate precoder information, may be provided by a reporting UE device for a set of neighbor UE devices within a maximum distance associated with the intermediate precoder. The reporting UE device for the intermediate precoder information may be the same device as the reporting UE device reporting the wide-beam precoder information or may be a different UE device. The reporting UE device reporting the intermediate precoder information, for example, may be a neighbor UE device listed in the neighbor list of the reporting UE device reporting the wide-beam precoder information. Where the same UE device reports both the wide-beam precoder information and the intermediate precoder information, the UE device may send multiple neighbor lists where each list is associated with different precoder information. In other situations, the reporting UE device may report a single neighbor list that identifies the different sets of neighbor UE devices. The neighbor list, for example, may include a designation for each UE device indicating the that the UE device belongs to set of UE devices that are within a particular maximum distance from the reporting UE device.

FIG. 1C is a block diagram of an example of an antenna beam configuration for a MU-MIMO precoder 160 that is equal to the product of a wide-beam precoder (W1), an intermediate-wide precoder (W3), and a UE-specific precoder (W2). For the example, a wide-beam antenna beam 162 results from a wide-beam precoder (R1), a first intermediate-wide antenna beam 164 results from a first intermediate-wide precoder (I1) and a second intermediate-wide antenna beam 164 results from a second intermediate-wide precoder (I2). Narrow (UE-specific) antenna beams 171-176 result from UE-specific precoders (N1, N2, N3, N4, N5, N6). The narrow antenna beam 172 results from the MU-MIMO precoder (W) equal to the product of R1, I1 and N2 (W=R1*I1*N2). Other precoder combination techniques may be used in some situations.

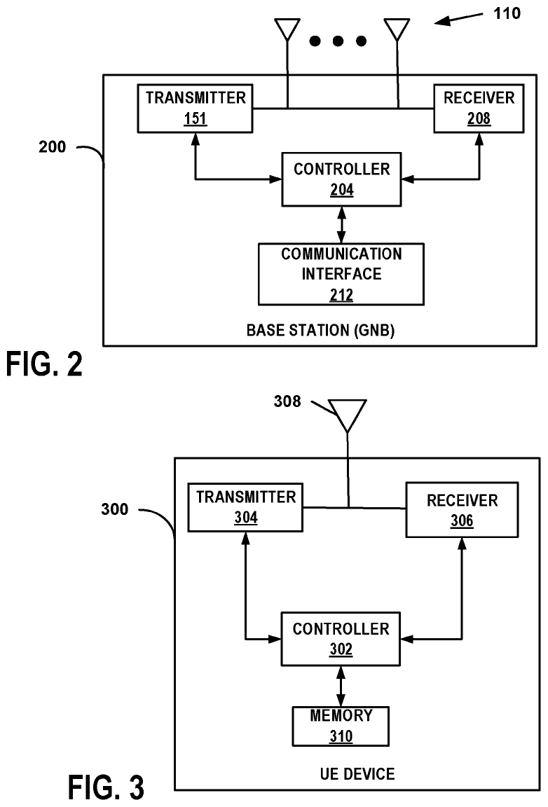

FIG. 2 is a block diagram of an example of a base station 200 suitable for use as the base station 108. The base station 200 includes a controller 204, transmitter 151, and receiver 208, and multiple antennas 110, as well as other electronics, hardware, and code. The base station 200 is any fixed, mobile, or portable equipment that performs the functions described herein. The various functions and operations of the blocks described with reference to the base stations 108, 200 may be implemented in any number of devices, circuits, or elements. Two or more of the functional blocks may be integrated in a single device, and the functions described as performed in any single device may be implemented over several devices. The base station 200 may be a fixed device or apparatus that is installed at a particular location at the time of system deployment. Examples of such equipment include fixed base stations or fixed transceiver stations. Although the base station may be referred to by different terms, the base station is typically referred to as a gNodeB or gNB when operating in accordance with one or more communication specifications of the 3GPP V2X operation. In some situations, the base station 200 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, the base station 200 may be a portable device that is not fixed to any particular location.

The controller 204 includes any combination of hardware, software, and/or firmware for executing the functions described herein as well as facilitating the overall functionality of the base station 200. An example of a suitable controller 204 includes code running on a microprocessor or processor arrangement connected to memory. The transmitter 151 includes electronics configured to transmit wireless signals. In some situations, the transmitter 206 may include multiple transmitters. The receiver 208 includes electronics configured to receive wireless signals. In some situations, the receiver 208 may include multiple receivers. The receiver 208 may receive signals through multiple antennas or through a selected antenna of the plurality of antennas 110. The antennas 110 may include separate transmit and receive antennas.

The transmitter 151 and receiver 208 in the example of FIG. 2 perform radio frequency (RF) processing including modulation and demodulation. The receiver 208, therefore, may include components such as low noise amplifiers (LNAs) and filters. The transmitter 151 may include filters and amplifiers. Other components may include isolators, matching circuits, and other RF components. These components in combination or cooperation with other components perform the base station functions. The required components may depend on the particular functionality required by the base station.

The transmitter 151 includes a modulator (not shown), and the receiver 208 includes a demodulator (not shown). The modulator modulates the signals to be transmitted as part of the downlink signals and can apply any one of a plurality of modulation orders. The demodulator demodulates any uplink signals received at the base station 200 in accordance with one of a plurality of modulation orders. The controller 204 in conjunction with the transmitter 151 apply the precoder matrix 150 to signals transmitted through the multiple antennas 110.

The base station 200 includes a communication interface 212 for transmitting and receiving messages with other base stations. The communication interface 212 may be connected to a backhaul or network enabling communication with other base stations. In some situations, the link between base stations may include at least some wireless portions. The communication interface 212, therefore, may include wireless communication functionality and may utilize some of the components of the transmitter 206 and/or receiver 208.

FIG. 3 is a block diagram of an example of a UE device 300 suitable for use as each of the UE devices 102, 115-118, 134, 136, 138, 142, 144, 146. In some examples, the UE device 300 is any wireless communication device such as a mobile phone, a transceiver modem, a personal digital assistant (PDA), a tablet, or a smartphone. In other examples, the UE device 300 is a machine type communication (MTC) communication device or Internet-of-Things (IOT) device. The UE device 300, therefore is any fixed, mobile, or portable equipment that performs the functions described herein. The various functions and operations of the blocks described with reference to UE device 300 may be implemented in any number of devices, circuits, or elements. Two or more of the functional blocks may be integrated in a single device, and the functions described as performed in any single device may be implemented over several devices.

The UE device 300 includes at least a controller 302, a transmitter 304 and a receiver 306. The controller 302 includes any combination of hardware, software, and/or firmware for executing the functions described herein as well as facilitating the overall functionality of a communication device. An example of a suitable controller 302 includes code running on a microprocessor or processor arrangement connected to memory 310. The transmitter 304 includes electronics configured to transmit wireless signals. In some situations, the transmitter 304 may include multiple transmitters. The receiver 306 includes electronics configured to receive wireless signals. In some situations, the receiver 306 may include multiple receivers. The receiver 304 and transmitter 306 receive and transmit signals, respectively, through antenna 308. The antenna 308 may include separate transmit and receive antennas. In some circumstances, the antenna 308 may include multiple transmit and receive antennas.

The transmitter 304 and receiver 306 in the example of FIG. 3 perform radio frequency (RF) processing including modulation and demodulation. The receiver 304, therefore, may include components such as low noise amplifiers (LNAs) and filters. The transmitter 306 may include filters and amplifiers. Other components may include isolators, matching circuits, and other RF components. These components in combination or cooperation with other components perform the communication device functions. The required components may depend on the particular functionality required by the communication device.

The transmitter 306 includes a modulator (not shown), and the receiver 304 includes a demodulator (not shown). The modulator can apply any one of a plurality of modulation orders to modulate the signals to be transmitted as part of the uplink signals. The demodulator demodulates the downlink signals in accordance with one of a plurality of modulation orders.

The UE device 300 is capable of transmitting and receiving sidelink signals to and from other UE devices as well as communicating with a base station. The controller 302, in conjunction with the receiver 306, measures signals, such as discovery signals, transmitted by nearby UE devices to generate the neighbor list that includes neighbor UE devices within the maximum distance. The neighbor list is stored in the memory 310 and transmitted to the base station 108 when the UE device 300 is a reporting UE device. The receiver 306 and controller 302 also measure signals transmitted by the base station to determine the wide-beam precoder and the UE-specific precoder information.

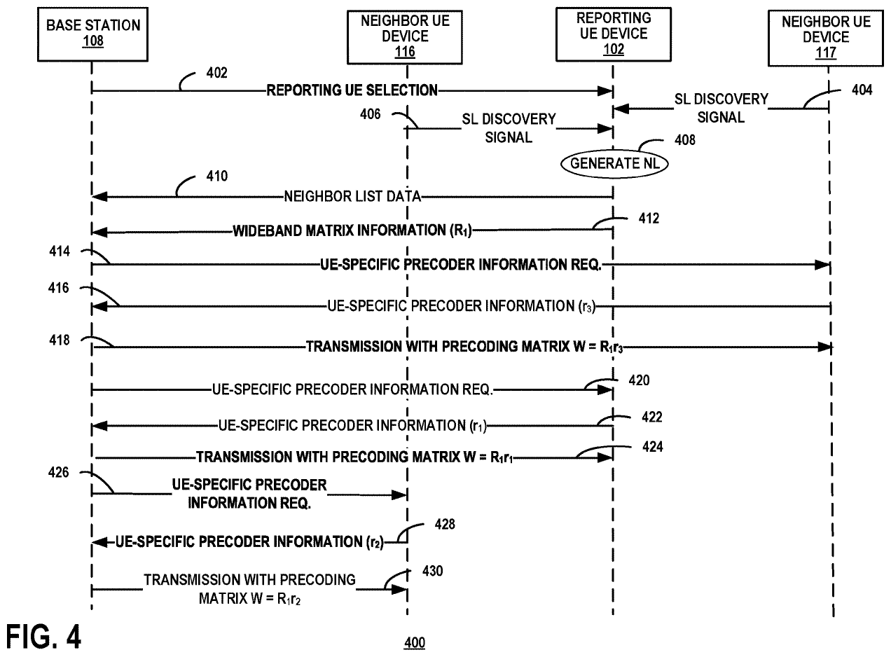

FIG. 4 is a message flow diagram 400 for an example where a precoder matrix is applied to transmissions to three UE devices 102, 116, 117 in a UE cluster 130 where the precoder matrix is the combination of a wide-beam precoder for the UE cluster provided by a reporting UE device 102 of the UE cluster and a UE-specific precoder measured by each UE device.

At transmission 402, the base station 108 sends a reporting UE selection message to instruct the reporting UE device 102 to report the neighbor list for precoding and the measured wideband precoding matrix, R₁. The reporting UE selection message may include additional information, such as the maximum distance, ¿, 120 and the schedule for reporting the neighbor list and/or the wide-beam precoder.

At transmission 404, a sidelink discovery signal is transmitted from the neighbor UE device 117 and received at the reporting UE device 102. At transmission 406, a sidelink discovery signal is transmitted from the neighbor UE device 116 and received at the reporting UE device 102. For the example, the sidelink discovery signals include either Layer 2 ID, S-TMSI or I-RNTI. The UE devices may be instructed by a base station to include S-TMSI or I-RNTI where the instruction may be provided via SIB or dedicated signaling. Other types of reference signals or other signals may be used for neighbor list generation.

At event 408, the reporting UE device 102 evaluates discovery signals (or other reference signals) transmitted by other UE devices to generate a NL. For the example, the reporting UE device 102 determines that the discovery signals transmitted by the UE device 116 and the UE device 117 meet the minimum criteria for including the UE devices in the neighbor list. Accordingly, the reporting UE device 102 generates a neighbor list that includes at least the UE devices 116, 117.

At transmission 410, the reporting UE device sends neighbor list data based on the neighbor list to the base station 108. The neighbor list data may be the neighbor list or may be data extracted from, or otherwise based on, the neighbor list. The neighbor list data at least identifies all of the neighbor UE device within the maximum distance of the reporting UE device 102.

At transmission 412, the reporting UE device 102 sends sideband matrix information to the base station 108 based on the measured wideband matrix, R₁. The sideband matrix information may be the measured wideband matrix, R₁ or may be other information, such an index in a table that identifies the measured matrix.

At transmission 414, the base station 108 requests UE-specific precoder information from the neighbor UE device 117. An example of a suitable request includes the base station utilizing the CSI-reportConfig to set the parameters for the UE device to provide. For the example, the UE device reports RI, CQI and the PMI in response to the request. The CSI-reportConfig includes the multi-antenna configurations of the base station, CSI resources, sub-bands to be reported, and the codebook details, as well as other information. The base station can configure the UE device to report back periodically and aperiodically. The UE device reports the measurements based on those settings in the CSI-measurementReport.

At transmission 416, the neighbor UE device 117 transmits UE-specific precoder information to the base station 108. The neighbor UE device 117 measures signals transmitted by the base station to determine the channel conditions and to determine the UE-specific precoder, r₃.

At transmission 418, the base station 108 transmits a signal to the neighbor UE device 117 through the multiple antennas 110 by applying a precoder matrix, W, that is equal to the combination of the wideband precoding matrix (R₁) for the first UE cluster and the UE-specific precoder (r₃) measured by the neighbor UE device 117. For the example, the combination of the precoders is the product of the precoder matrices.

At transmission 420, the base station 108 requests UE-specific precoder information from the reporting UE device 102.

At transmission 422, the reporting UE device 102 transmits UE-specific precoder information to the base station 108. The reporting UE device 102 measures signals transmitted by the base station 108 to determine the channel conditions and to determine the UE-specific precoder, r₁.

At transmission 424, the base station 108 transmits a signal to the reporting UE device 102 through the multiple antennas 110 by applying a precoder matrix, W, that is equal to the product of the wideband precoding matrix (R₁) for the first UE cluster and the UE-specific precoder (r₁) measured by the reporting UE device 102.

At transmission 426, the base station 108 requests UE-specific precoder information from the neighbor UE device 117.

At transmission 428, the neighbor UE device 116 transmits UE-specific precoder information to the base station 108. The neighbor UE device 117 measures signals transmitted by the base station to determine the channel conditions and to determine the UE-specific precoder, r₂.

At transmission 430, the base station 108 transmits a signal to the neighbor UE device 116 through the multiple antennas 110 by applying a precoder matrix, W, that is equal to the product of the wideband precoding matrix (R₁) for the first UE cluster and the UE-specific precoder (r₂) measured by the neighbor UE device 116.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A reporting user equipment (UE) device comprising:
a receiver configured to receive a signal from each of a plurality of other UE devices;
a controller configured to identify a subset of UE devices of the plurality of other UE devices based, at least partially, on the signals and a maximum distance such that each distance from the reporting UE device to each UE device of the subset is less than the maximum distance, the controller configured to identify wide-beam information identifying a wide-beam precoder for a Multiple User Multiple Input Multiple Output (MU-MIMO) precoder applied by a base station for transmission through multiple antenna elements at the base station to the reporting UE device, the MU-MIMO precoder formed by a combination of the wide-beam precoder and at least one other precoder; and
a transmitter configured to transmit, to the base station, the wide-beam information and a neighbor list identifying the subset of UE devices.

2. The reporting UE device of claim 1, wherein the MU-MIMO precoder is formed by a combination of the wide-beam precoder and one frequency-selective precoder.

3. The reporting UE device of claim 1, wherein the MU-MIMO precoder is formed by a combination of the wide-beam precoder, an intermediate-beam precoder, and one narrow beam precoder.

4. The reporting UE device of claim 1, wherein the wide-beam information is one of a precoder indicator (PMI), a Synchronization Signal Block (SSB) indicator indicating an SSB, channel estimate information, or an index in a codebook.

5. The reporting UE device of claim 1, wherein the receiver is further configured to receive a maximum distance parameter indicative of the maximum distance.

6. The reporting UE device of claim 1, wherein:
the receiver is further configured to receive a narrow beam measurement configuration from the base station;
the controller is further configured to determine narrow beam information by applying the narrow beam measurement configuration to measure Channel State Information (CSI);
the transmitter is further configured to transmit the CSI to the base station; and
the narrow beam precoder is based on the CSI.

7. The reporting UE device of claim 1, wherein the wide-beam information identifies a subset of antenna beams of a plurality of antenna beams from the base station and the at least one other precoder adjusts a phase and amplitude of each antenna beam of the subset of antenna beams and linearly combines the subset of antenna beams.

8. The reporting UE device of claim 1, wherein the controller is configured to determine each distance based on a signal strength of each signal.

9. The reporting UE device of claim 1, wherein the controller is configured to determine each distance based on a geographical location of each of the plurality of other UE devices.

10. The reporting UE device of claim 9, wherein each signal comprises the geographical location of the other UE device transmitting the signal.

11. The reporting UE device of claim 1, wherein:
the receiver is configured to receive, from the base station, a request for UE-specific precoder information;
the controller is configured to determine the UE-specific precoder information based on the request;
the transmitter is configured to transmit, to the base station, UE-specific precoder information; and
the at least one other precoder is based on the UE-specific precoder information.

12. The reporting UE device of claim 11, wherein the UE specific precoder information is one of a precoder indicator (PMI), channel estimate information, a beam indicator indicating at least one antenna beam, or an index in a codebook.

13. The reporting UE device of claim 1, wherein the wideband precoding matrix is used by the base station for the MU-MIMO precoding matrix for transmissions to all UE devices identified by the neighbor list.

14. A base station comprising:
a receiver configured to receive a neighbor list from a reporting user equipment (UE) device, the neighbor list identifying neighbor UE devices within a maximum distance from the reporting UE device, the receiver further configured to receive, from the reporting UE device, wide-beam precoder information indicative of a wide-beam precoder;
a plurality of antennas; and
a transmitter configured to apply a Multiple User Multiple Input Multiple Output (MU-MIMO) precoder when transmitting through the plurality of antennas, the MU-MIMO precoder equal to a combination of the wide-beam precoder and at least one other precoder, the transmitter configured to apply the wide-beam precoder for transmissions to the reporting UE device and the neighbor UE devices.

15. The base station of claim 14, wherein the receiver is further configured to receive, from the reporting UE device, first UE-specific precoder information indicative of a first UE-specific precoder and to receive, from one of the neighbor UE devices, second UE-specific precoder information indicative of a second UE-specific precoder, the transmitter configured to apply the first MU-MIMO precoder to a first transmission to the reporting UE device and to apply a second MU-MIMO precoder to a second transmission to the one of the neighbor UE devices, the first MU-MIMO precoder equal to a combination of the wide-beam precoder and the first UE-specific precoder, the second MU-MIMO precoder equal to a combination of the wide-beam precoder and the second UE-specific precoder.

16. The base station of claim 15, wherein the transmitter is further configured to transmit a first request for UE-specific precoder information to the reporting UE device and to transmit a second request for UE-specific precoder information to the one of the neighbor UE devices.

17. The base station of claim 16, wherein:
the controller is configured to determine a precoder measurement configuration based on the wide-beam precoder information,
the first request for UE-specific precoder information comprises the precoder measurement configuration identifying measurements to determine the first UE-specific information, and
the second request for UE-specific precoder information comprises the precoder measurement configuration identifying measurements to determine the second UE-specific information.

18. A neighbor user equipment (UE) device comprising:
a transmitter configured to transmit a sidelink discovery signal to a reporting UE device; and
a receiver configured to receive, from a base station, a request for UE-specific precoder information,
the transmitter configured to transmit, to the base station, the UE-specific precoder information,
the receiver configured to receive a transmission transmitted by the base station through a plurality of antennas using a Multiple User Multiple Input Multiple Output (MU-MIMO) precoder equal to a combination of the UE-specific precoder and a wide-beam precoder, the wide-beam precoder determined by the base station based at least partially on wide-beam precoder information provided by the reporting UE device.

19. The neighbor UE device of claim 18, wherein the UE specific precoder information is one of a precoding matrix indicator (PMI), channel estimate information, a beam indicator indicating at least one antenna beam, or an index in a codebook.
